(19) United States
(12) Patent Application Publication
(10) Pub. No.: US 2023/0330883 A1
(43) Pub. Date: Oct. 19, 2023

(54) APPARATUS FOR MACHINING A SKI

(71) Applicant: Wintersteiger AG, Ried im Innkreis (AT)

(72) Inventors: Johann Aigner, Neuhofen im Innkreis (AT); Guenter Richard Feichtinger, St. Florian/Inn (AT); Christoph Niklas, Ried im Innkreis (AT); Robert Berger, Bachmanning (AT)

(73) Assignee: Wintersteiger AG, Ried im Innkreis (AT)

(21) Appl. No.: 18/022,287

(22) PCT Filed: Aug. 19, 2021
(86) PCT No.: PCT/AT2021/060289

§ 371 Date: Feb. 21, 2023

(30) Foreign Application Priority Data
Aug. 31, 2020 (AT) A50736/2020

(51) Int. Cl. B26D 7/06; B26D 3/00

(52) U.S. Cl. CPC B26D 7/0625; B26D 3/00

(57) ABSTRACT

An apparatus for machining a ski includes a support for the ski and a device for conveying the ski in the longitudinal direction of the ski, along the support. The support is assigned a device for machining the side walls of the ski using at least one cutting tool, which is arranged on a tool carrier, the latter being guided adjustably in a direction transverse to the conveying direction and parallel to the support, and which, with the aid of a resilient actuator for the tool carrier, can be positioned, with resilient prestressing, against that side wall of the ski being conveyed along the support which is to be machined.

### TECHNICAL FIELD

The system described herein relates to an apparatus for machining a ski that includes a support for the ski and a device for conveying the ski in a longitudinal direction of the ski along the support.

### BACKGROUND

Apparatuses are known for machining the steel edges of a ski, in which the steel edges of the ski, which is guided on a support in the longitudinal direction, are ground with the aid of two tools which are opposite each other with respect to the ski and which are applied to the ski with an appropriate setting force and thus automatically follow the longitudinal course of the steel edges when the ski is moved in the longitudinal direction with respect to the grinding tools. To increase the effectiveness of the grinding process, the side edges of the steel edges to be ground can be exposed by removing the side walls of the ski. AT 413 651 B shows such a device for removing the side walls of a ski with the aid of a cutting edge arranged on a handle part provided with a guide surface. To machine the ski, the handle part with the guide surface is placed on the running surface of the ski and moved by hand along the longitudinal edge of the ski, where the cutting edge removes the side wall of the ski adjacent to the steel edge by chip removal in order to make the steel edge more accessible for a subsequent grinding process.

A disadvantage, however, is that the chip-removing machining of the side walls must be carried out manually, which means that the machining quality depends on the manual skill of the user. In addition, separate machining of the side walls of a ski by hand prior to machine edge grinding is time-consuming and is therefore usually omitted with the consequence that a higher number of grinding cycles for machining the steel edges is accepted, which in turn shortens the service life of the grinding tools in relation to the number of skis that can be machined.

### SUMMARY OF THE INVENTION

The system described herein is thus based on the object of creating a machining apparatus with the aid of which the side walls of a ski can be easily removed to a predetermined quality with a comparatively low expenditure of time before edge grinding.

Starting from a machining apparatus of the type described at the beginning, the system described herein solves the set object in such a way that the support is assigned a device for machining the side walls of the ski using at least one cutting tool, which is arranged on a tool carrier, the latter being guided adjustably in a direction transverse to the conveying direction and parallel to the support, and which, with the aid of a resilient actuator for the tool carrier, can be positioned, with resilient prestressing, against that side wall of the ski being conveyed along the support which is to be machined.

Since the device for chip-removing machining of the side walls of a ski is used in conjunction with a machining apparatus which has a support for the ski along which the ski is conveyed in the longitudinal direction, the ski guide can be used advantageously for the device for side wall machining because the support forms a structural reference specification for the device for side wall machining, which is an essential prerequisite for precise guidance of the cutting tool with respect to the running surface distance. The longitudinal guidance of the cutting tool along the ski sidecut results automatically during the ski conveying in longitudinal direction due to the resilient loading of the tool carrier transverse to the conveying direction of the ski. This transverse loading of the tool carrier, which can be adjusted parallel to the support and transversely to the conveying direction, causes the cutting tool to be applied to the side wall of the ski with a presettable application force, where the side wall or the steel edge itself takes over the guidance of the cutting tool during the advance of the ski. Due to the spring-loaded application of the tool carrier transversely to the side wall of the ski, the device also becomes independent of the width and edge profile of the ski to be processed, so that the side walls of all possible types of skis, including snowboards, can be processed without the need for costly retooling of the machining apparatus.

Although various measures can be taken to displace the tool carrier transversely to the side wall of the ski to be machined, e.g. the tool carrier could be provided for this purpose on an arm that can be pivoted about an axis perpendicular to the ski support, simple, space-saving design conditions result if the device for machining the side walls of the ski has a frame with a guide rail extending transversely to the conveying direction and parallel to the support for the tool carrier that can be driven by the spring-loaded actuator.

In order to be able to machine the two side walls of a ski simultaneously, the device for machining the side walls of the ski can advantageously include a frame with two tool carriers, provided on both sides of the support and displaceable transversely to the conveying direction and parallel to the support, for one cutting tool each, as well as an actuator for the resilient loading of the tool carriers. Simultaneous machining of the two side walls of a ski not only has the advantage of shortening the machining time, but also simplifies the ski guidance between the cutting tools set against the ski from opposite sides, so that an otherwise necessary ski support on the side of the ski opposite the cutting tool is unnecessary.

In this case, a common guide rail running transverse to the conveying direction and parallel to the support can advantageously be provided for the two tool carriers in the frame.

In order not to interfere with the processing of the ski following the removal of the side walls, in particular the edge grinding, by the device for machining the side walls, it is sufficient to free the ski laterally by moving the tool carriers away from the ski. This can be carried out by the spring-loaded actuators, but also by additional actuators, with the aid of which it is possible, for example, to adapt to different width ranges of the skis and snowboards.

If the frame is mounted so that it can be pivoted about a pivot axis parallel to the conveying direction between a working position and a maintenance position, access to the cutting tools, but also to equipment of the machining apparatus in the area of the frame, can be released in a simple manner.

In order to be able to adjust the resilient contact between the cutting tools and the side walls of the ski according to the respective requirements, the resilient prestressing of the cutting tool contact can be adjusted by appropriate measures in the area of the actuators for the respective tool carrier. This is achieved in a particularly advantageous manner if a pneumatic cylinder is provided as the actuator in each case, although this is by no means mandatory. The choice of the spring prestressing of the cutting tool setting directly influences the chip thickness of the chips to be removed from the side walls of the ski.

The chips separated from the side wall contaminate the working area and can hinder the automated machining process. This can be avoided by the device comprising at least one nozzle for removing the chips. The nozzle sprays flushing fluid in the direction of the side wall in such a way that the chips produced by the cutting process are moved by the pressure of the flushing fluid into an area provided for this purpose, for example a collecting basin. Advantageously, air or water can be used as the flushing fluid.

### BRIEF DESCRIPTION OF DRAWINGS

The subject matter of the system described herein is shown in the drawings by way of example, wherein:

FIG. 1 shows a machining apparatus according to the system described herein in a sectional plan view and

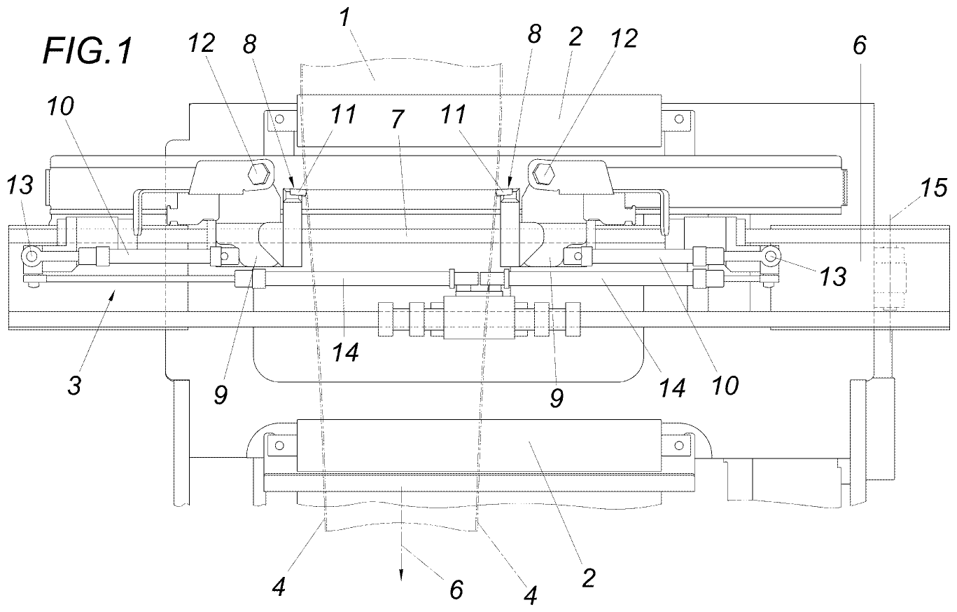

FIG. 2 shows the machining apparatus according to FIG. 1 in a partially exposed front view on a larger scale.

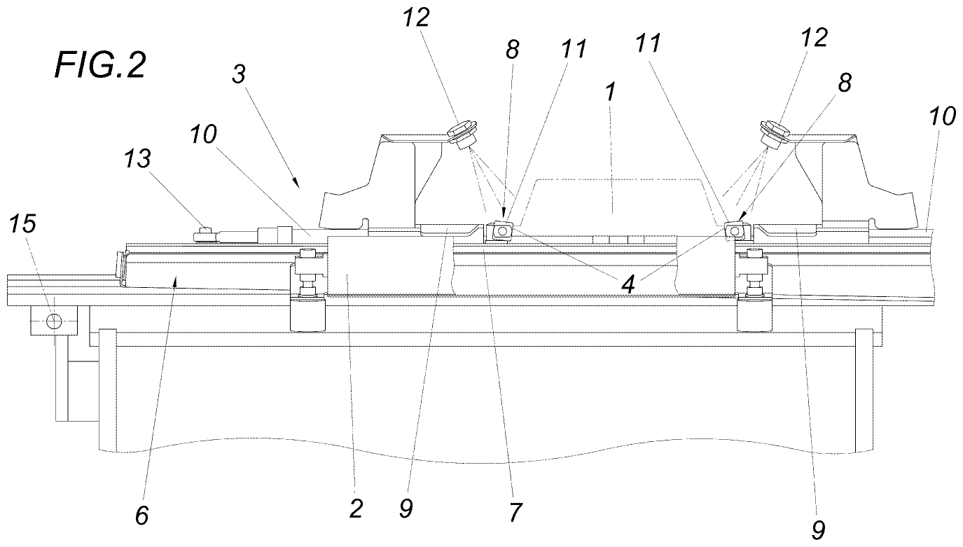

### DETAILED DESCRIPTION OF VARIOUS EMBODIMENTS

The illustrated machining apparatus for a ski 1 includes a support 2 for the ski 1 in the form of a roller table and a conveying device for the ski 1 in the longitudinal direction of the ski along the support 2. This ski guide is assigned the usual tools for processing the steel edges or the running surface of the ski 1, although this is not shown for reasons of clarity. New to this machining apparatus is an additional device 3 for machining the side walls 4 of the ski 1. This device 3 has a frame 5 which comprises a guide rail 7, extending transversely to the conveying direction 6 and parallel to the support 2, for two tool carriers 9 each accommodating a cutting tool 8. The carriage-like tool carriers 9 are engaged by spring-loaded actuators 10, with the aid of which the cutting tools 8 are placed under spring-loaded prestressing against the side walls 4 of the ski 1 conveyed along the support 2 of the machining apparatus. When the ski 1 is moved longitudinally with respect to the device 3, the cutting tools 8 separate a chip from the side walls 4 of the ski 1, thus exposing the side edges of the steel edges of the ski 1 for a better grinding operation.

Advantageously, indexable inserts 11 are used as cutting tools 8, but this is not mandatory because it is only a matter of machining the side walls 4 of the ski 1 adjoining the steel edges, so that all cutting tools suitable for this purpose, including driven milling cutters, could be used.

The actuators 10 for the resilient loading of the tool carriers 9 are designed as pneumatic cylinders according to the exemplary embodiment shown, via which the application force of the cutting tools 8 to the side walls 4 of the ski 1 can be adjusted depending on the respective requirements. In order to prevent the chips separated by the cutting tools 8 from obstructing the machining process or contaminating the working area, at least one nozzle 12 for a flushing fluid can be provided for each side wall 4, with the aid of which the chips can be conveyed away and discharged from the ski area.

As already mentioned, the device 3 can be used to machine the side walls of skis of different widths, including snowboards. In order to be able to provide short adjustment paths for the pneumatic cylinders 11, the frame-fixed articulation points 13 of these pneumatic cylinders 11 can be adjusted in the adjustment direction.

For this purpose, an actuator 14, for example an actuating cylinder, is provided for each of these articulation points 13.

In order to facilitate access to the cutting tools 8 or to functional parts of the machining apparatus arranged in the area of the frame 5, the frame 5 can be pivoted away from the support 2 about an axis 15 aligned parallel to the conveying direction 6 into a maintenance position from the working position shown.

1. A machining apparatus for a ski, comprising:
a support for the ski;
a conveying device that conveys the ski in a longitudinal direction of the ski along the support; and
a device for machining side walls of the ski using at least one cutting tool, which is arranged on a tool carrier that is guided adjustably in a direction transverse to a conveying direction and parallel to the support wherein a resilient actuator for the tool carrier is positionable with resilient prestressing against the side wall of the ski being conveyed along the support.

2. A machining apparatus according to claim 1, wherein the device for machining the side walls of the ski has a frame with a guide rail, extending transversely to the conveying direction and parallel to the support, for the tool carrier which can be driven by the resilient actuator.

3. A machining apparatus according to claim 1, wherein the device for machining the side walls of the ski includes a frame with two tool carriers, provided on both sides of the support and displaceable transversely to the conveying direction and parallel to the support, for a cutting tool in each case, as well as an actuator for resiliently acting on the tool carriers.

4. A machining apparatus according to claim 3, wherein the frame has a common guide rail for the two tool carriers extending transversely to the conveying direction and parallel to the support.

5. A machining apparatus according to claim 2, wherein the frame is pivotably mounted about a pivot axis parallel to the conveying direction between a working position and a maintenance position.

6. A machining apparatus according to claim 1, wherein the resilient prestressing of the cutting tool setting is adjustable.

7. A machining apparatus according to claim 1, wherein the actuator is a pneumatic cylinder.

8. A machining apparatus according to claim 1, wherein the device has at least one nozzle for removing the chips produced during side wall machining.

9. A machining apparatus according to claim 3, wherein the frame is pivotably mounted about a pivot axis parallel to the conveying direction between a working position and a maintenance position.

10. A machining apparatus according to claim 4, wherein the frame is pivotably mounted about a pivot axis parallel to the conveying direction between a working position and a maintenance position.

11. A machining apparatus according to claim 2, wherein the resilient prestressing of the cutting tool setting is adjustable.

12. A machining apparatus according to claim 3, wherein the resilient prestressing of the cutting tool setting is adjustable.

13. A machining apparatus according to claim 4, wherein the resilient prestressing of the cutting tool setting is adjustable.

14. A machining apparatus according to claim 5, wherein the resilient prestressing of the cutting tool setting is adjustable.

15. A machining apparatus according to claim 3, wherein the actuator is a pneumatic cylinder.

16. A machining apparatus according to claim 4, wherein the actuator is a pneumatic cylinder.

17. A machining apparatus according to claim 5, wherein the actuator is a pneumatic cylinder.

18. A machining apparatus according to claim 6, wherein the actuator is a pneumatic cylinder.

19. A machining apparatus according to claim 5, wherein the device has at least one nozzle for removing the chips produced during side wall machining.

20. A machining apparatus according to claim 6, wherein the device has at least one nozzle for removing the chips produced during side wall machining.
